(19) United States
(12) Patent Application Publication
(10) Pub. No.: US 2017/0316865 A1
(43) Pub. Date: Nov. 2, 2017

(54) INTEGRATED INDUCTOR

(71) Applicant: Murata Manufacturing Co., Ltd., Kyoto (JP)

(72) Inventor: Jianxin SHENG, Nagaokakyo-shi (JP)

(73) Assignee: Murata Manufacturing Co., Ltd., Kyoto (JP)

(21) Appl. No.: 15/497,625

(22) Filed: Apr. 26, 2017

(30) Foreign Application Priority Data
Apr. 28, 2016 (JP) 2016-090371

(51) Int. Cl. H01F 27/28; H01F 27/245

(52) U.S. Cl. CPC H01F 27/28; H01F 27/245

(57) ABSTRACT

An integrated inductor acquired by integrating a plurality of coils, includes a first coil group arranged with winding axes aligned on a first straight line, and a second coil group arranged with winding axes aligned on a second straight line. The first coil group and the second coil group have respective coils being in a staggered arrangement. The first coil group and the second coil group have respective coils partially overlapping with each other when viewed in a winding axis direction.

### CROSS REFERENCE TO RELATED APPLICATIONS

This application claims benefit of priority to Japanese Patent Application 2016-090371 filed Apr. 28, 2016, the entire content of which is incorporated herein by reference.

### TECHNICAL FIELD

The present disclosure relates to an integrated inductor acquired by integrating a plurality of inductors such that coupling between respective coils is substantially zero.

In an electronic circuit, a plurality of identical electronic components is used in some cases. In such a case, to reduce a mounting area, an integrated electronic component acquired by integrating a plurality of electronic components is used. Even in the case of an inductor, an integrated inductor acquired by integrating a plurality of inductors may be used. In general, the integrated inductor must have magnetic coupling between inductors made as small as possible so as to prevent each coil from affecting another coil.

### SUMMARY

### Problem to be Solved by the Disclosure

FIGS. 16A and 16B are views for explaining a structure of a conventional integrated inductor described in Japanese Laid-Open Patent Publication No. 2003-224013, FIG. 16A is a perspective view, and FIG. 16B is a longitudinal sectional view taken along 1-1 of FIG. 16A.

As shown in FIGS. 16A and 16B, an integrated inductor 5 is a ferrite inductor made up of E-cores 6, 7 having an E-shaped cross-section made of ferrite, a plate-like I-core 8 made of ferrite, coils 1, 2 wound into a ring shape, and a base 9 made of a resin. The integrated inductor 5 is called a two-in-one inductor.

The E-cores 6, 7 have the coils 1 and 2, respectively, stored therein and are disposed on both sides of the I-core 8 and mounted on the base 9. Terminals 1A, 1B of the coil 1 and terminals 2A, 2B of the coil 2 are led out from a lower surface of the base 9 as mounting terminals.

The integrated inductor 5 has gaps G provided between a middle leg 6a of the E-core 6 and the I-core 8 as well as between a middle leg 7a of the E-core 7 and the I-core 8. Since these gaps G act as magnetic resistance, the magnetic coupling between the coil 1 and the coil 2 is suppressed. Nevertheless, the integrated inductor has a problem that the coupling coefficient between the coil 1 and the coil 2 is 1% or more and cannot be made zero.

In the case of a dust inductor having a coil buried in a magnetic-powder-containing resin frequently used in recent years, a gap is difficult to provide and, even if a gap is provided, since the relative permeability of the magnetic-powder-containing resin is about several tens and significantly lower than the relative permeability of ferrite, which is several hundreds, the gap has a little effect of suppressing the coupling coefficient and the coupling coefficient becomes considerably large. Therefore, the integrated inductor has a problem that the dust inductor is not suitable for the integrated inductor.

### Means for Solving Problem

An integrated inductor of the present disclosure is an integrated inductor acquired by integrating a plurality of coils, comprising:

a first coil group arranged with a winding axis aligned on a first straight line; and

a second coil group arranged with a winding axis aligned on a second straight line,

the first coil group and the second coil group having respective coils being in a staggered arrangement,

the first coil group and the second coil group having respective coils partially overlapping with each other when viewed in a winding axis direction.

### Effect of the Disclosure

According to the integrated inductor of the present disclosure, the integrated inductor having a simple structure and substantially zero magnetic coupling between coils can be provided.

### BRIEF DESCRIPTION OF THE DRAWINGS

FIG. 1 is a transparent perspective view of a first embodiment of an integrated inductor of the present disclosure.

FIG. 2 is a longitudinal sectional view of the first embodiment of the integrated inductor of the present disclosure.

FIG. 3 is a simulation result of the first embodiment of the integrated inductor of the present disclosure.

FIG. 4 is a simulation result of the first embodiment of the integrated inductor of the present disclosure.

FIG. 5 is a schematic cross-sectional view for explaining the principle of the integrated inductor of the present disclosure.

FIG. 6 is a perspective view of a second embodiment of the integrated inductor of the present disclosure.

FIG. 7A is a longitudinal sectional view of the second embodiment of the integrated inductor of the present disclosure.

FIG. 7B is a longitudinal sectional view of the second embodiment of the integrated inductor of the present disclosure.

FIG. 8 is a simulation result of the second embodiment of the integrated inductor of the present disclosure.

FIG. 9 is a circuit diagram of a typical digital amplifier.

FIG. 10 is a longitudinal sectional view of a third embodiment of the integrated inductor of the present disclosure.

FIG. 11 is a simulation result of the third embodiment of the integrated inductor of the present disclosure.

FIG. 12 is a simulation result of a digital amplifier when inductors are coupled in a channel.

FIG. 13A is a simulation result of a digital amplifier when inductors are not coupled between channels.

FIG. 13B is a simulation result of a digital amplifier when inductors are coupled between channels.

FIG. 14 is a circuit diagram of a multi-channel DC-DC converter.

FIG. 15 is a longitudinal sectional view of a fourth embodiment of the integrated inductor of the present disclosure.

FIG. 16A is a perspective view of a conventional integrated inductor.

FIG. 16B is a longitudinal sectional view of a conventional integrated inductor.

### DETAILED DESCRIPTION

### Embodiments

### First Embodiment

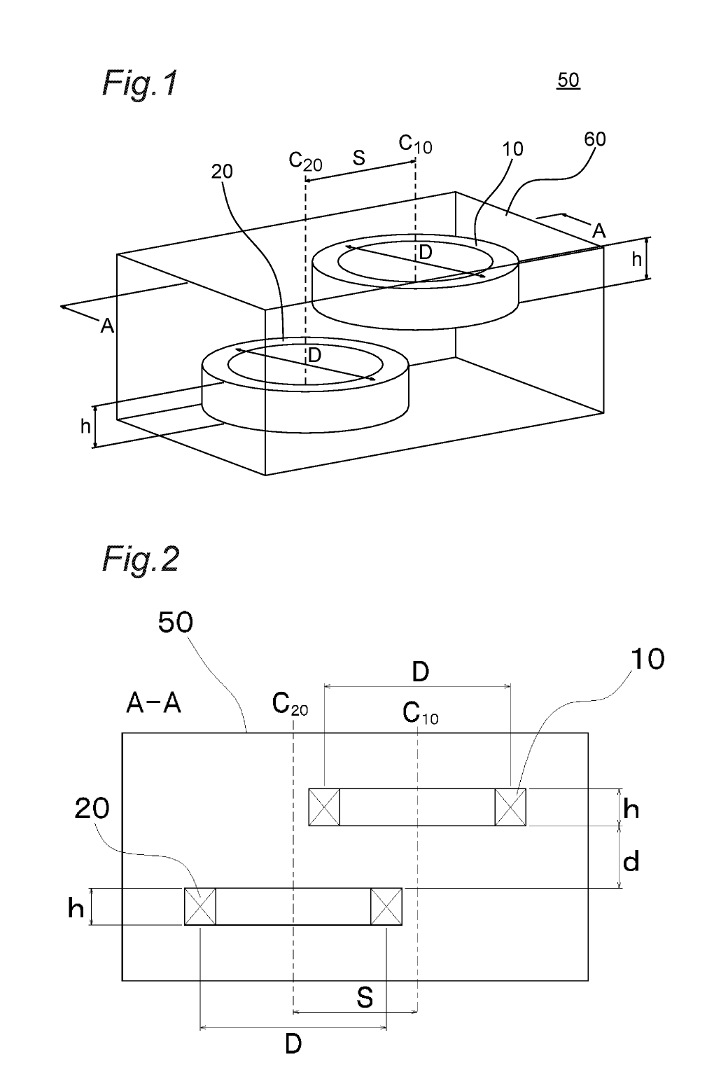

FIG. 1 is a transparent perspective view of a first embodiment of an integrated inductor of the present disclosure and FIG. 2 is a longitudinal sectional view thereof.

As shown in FIGS. 1 and 2, an integrated inductor 50 is a dust inductor integrally molded with two coils 10, 20 of insulation-coated conductive wires wound into a ring shape and buried in a magnetic-powder-containing resin 60.

The coil 10 and the coil 20 have the same shape and the same dimensions and have opening planes arranged in parallel such that the opening planes partially overlap with each other when viewed in a winding axis direction of the coils.

Terminals of the coils 10, 20 are led out to the exterior of the integrated inductor 50 as mounting terminals with the insulation coating peeled off.

When the coils 10, 20 have an average diameter of D, a height of h, an axis C₁₀ as the winding axis of the coil 10, and an axis C₂₀ as the winding axis of the coil 20, the axis C₁₀ and the axis C₂₀ are parallel, and the axis C₁₀ and the axis C₂₀ are separated by a distance S. The opening planes facing each other between the coil 10 and the coil 20 are separated by a distance d. In this case, an average diameter is (outer diameter+inner diameter)/2.

A distance between axes and a distance between opening planes facing each other will hereinafter be referred to as an axial interval and a coil interval, respectively.

As a result of the following two kinds of simulations, the inventor discovered that the coupling between the coil 10 and the coil 20 may become substantially zero in some cases.

### (Simulation 1)

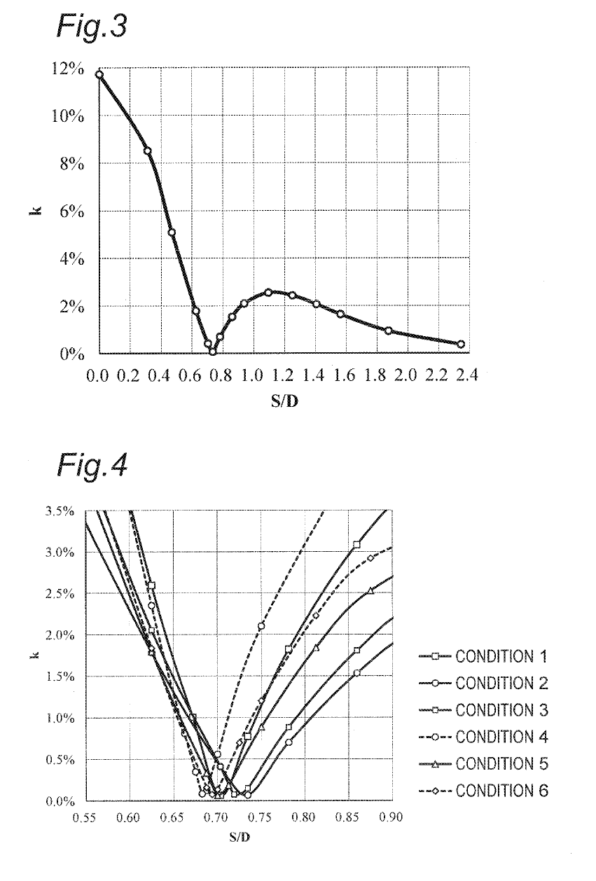

First, the two coils 10, 20 having the average diameter D=6.4 mm, the height h=2.5 mm, and the number of turns N=10 were buried in a magnetic-powder-containing resin with the coil interval d=2 mm to simulate a coupling coefficient between the coil 10 and the coil 20 when the axial interval S was varied. FIG. 3 is a graph showing the result. In FIG. 3, the horizontal axis indicates S/D and the vertical axis indicates a coupling coefficient k. Since the average diameter D is constant, when the horizontal axis S/D is larger, the winding axes of the two coils are farther from each other, and S/D<1 represents that the opening planes partially overlap with each other in a planar view.

From the result of FIG. 3, it was found that the coupling coefficient k becomes substantially zero at S/D=0.7.

### (Simulation 2)

Next, the same simulation was performed under Conditions 1 to 6 shown in Table 1. FIG. 4 is a graph showing the result. In FIG. 4, the horizontal axis indicates S/D and the vertical axis indicates the coupling coefficient k.

From the result of FIG. 4, it was found that although varying depending on the conditions of the average diameter D, the coil interval d, the height h, and the number of turns N, the coupling coefficient k becomes substantially zero depending on the axial interval S.

TABLE 1

| CONDITIONS | D [mm] | d [mm] | h [mm] | N [TIMES] |
|---|---|---|---|---|
| 1 | 6.4 | 1.2 | 2.50 | 10 |
| 2 | 6.4 | 2.0 | 2.50 | 10 |
| 3 | 6.4 | 2.0 | 1.25 | 5 |
| 4 | 8.0 | 1.0 | 2.25 | 9 |
| 5 | 8.0 | 2.0 | 2.25 | 9 |
| 6 | 8.0 | 2.0 | 1.00 | 4 |

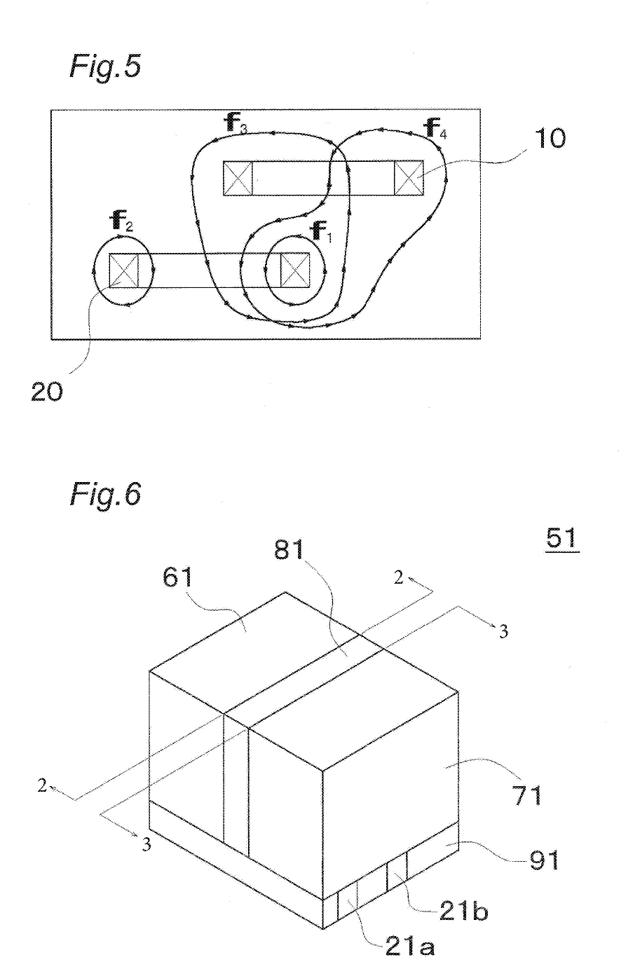

Description will hereinafter be made of the principle of the coupling coefficient becoming zero between the coils of the integrated inductor of this embodiment with reference to a schematic longitudinal sectional view of FIG. 5.

As shown in FIG. 5, when a current is applied to the coil 20, magnetic fluxes f1, f2 circling closely around the coil 20 and magnetic fluxes f3, f4 circling remotely around the coil 20 are generated. The magnetic fluxes f1, f2 circle only around the coil 20, and the magnetic flux f3 goes through the hole of the coil 10 upward in FIG. 5 while circling around, and the magnetic flux f4 goes through the hole of the coil 10 downward in FIG. 5 while circling around.

Since the magnetic flux f3 and the magnetic flux f4 penetrate the coil 10 in opposite directions, only the absolute value |f4−f3| of the difference of the magnetic flux f3 and the magnetic flux f4 contributes to the magnetic coupling between the coils. Since the magnitudes of the magnetic flux f3 and the magnetic flux f4 vary depending on the axial interval S, the coupling coefficient k can be made substantially zero by setting the axial interval S such that the magnetic flux f3 and the magnetic flux f4 become substantially equal.

The principle described above will be applied to FIG. 3 for discussion.

At S/D=0, i.e., when the winding axes of the coil 10 and the coil 20 are identical, the coupling coefficient k is about 12%.

As S/D becomes larger, i.e., as the overlap between the coil 10 and the coil 20 becomes smaller, the magnetic flux f4 decreases and the magnetic flux f3 increases, so that |f4−f3| is reduced. As a result, the coupling coefficient k gradually decreases.

At S/D=0.73, the magnetic flux f4 and the magnetic flux f3 become equal, and as a result, the coupling coefficient k=0 is achieved.

When S/D further increases, the magnetic flux f3 becomes larger than the magnetic flux f4, so that the sign of f4−f3 is inverted, and |f4−f3| increases. As a result, the coupling coefficient k increases again.

When S/D becomes larger than one and the coil 10 and the coil 20 are completely separated from each other, the influence between the coils becomes small, so that the coupling coefficient k converges to zero.

In the integrated inductor 50, the coil 10 and the coil 20 may not integrally be molded. It is generally difficult to control relative positions between coils after molding in a dust inductor. Therefore, the structure shown in FIG. 2 may be achieved by combining two dust inductors each having a coil buried such that the centers of the coils are shifted from each other.

Additionally, from the comparison of the results between Conditions 2 and 3 as well as between Conditions 5 and 6, the change in the coupling coefficient k tends to be gentler when the height h of the coils is higher. If the positions of the coils to be buried are difficult to control as in the case of the dust inductor, the height h of the coil may instead be increased as far as possible to reduce the change in the coupling coefficient k so as to facilitate manufacturing.

It is noted that the coupling coefficient k to some extent may be allowed in some practical applications, and thus it is unnecessary to adjust positions precisely to zero coupling coefficient. For example, in the case of the dust inductor of Condition 3, if only the S/D is controlled in the range of around 0.67˜0.79, the coupling coefficient k less than 1% may be obtained. This value is approximately the same level as that of the conventional gap-added integrated inductor mentioned above.

### Second Embodiment

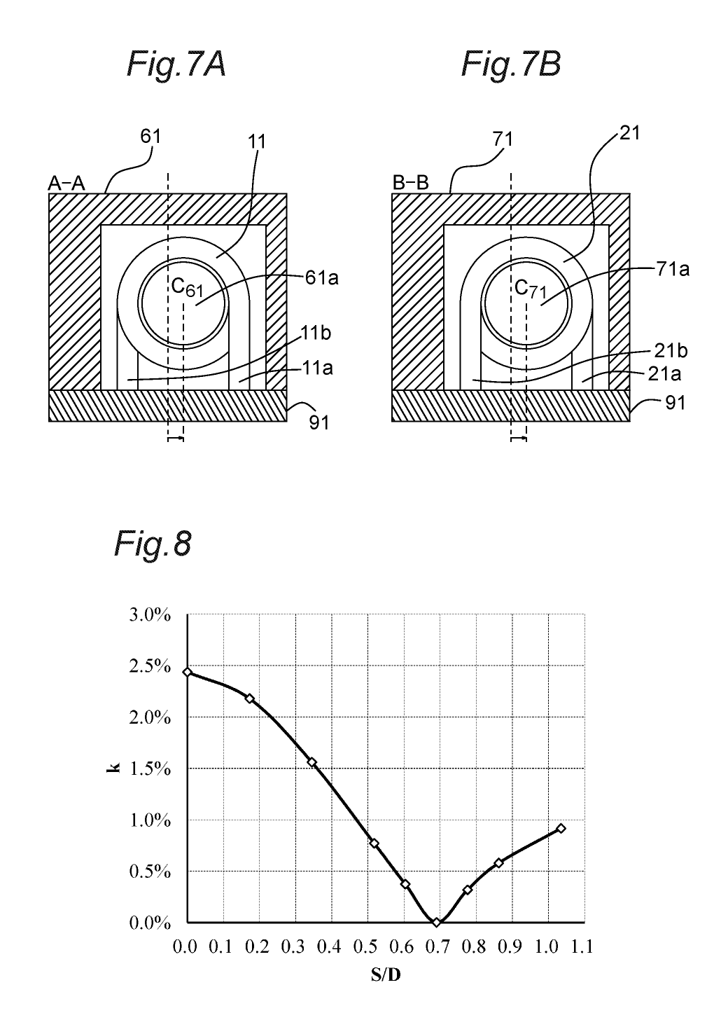

Although the integrated inductor described above is an integrated inductor formed by powder compacting molding, the principle described above holds even in the case of an integrated inductor made of ferrite. FIGS. 6, 7A and 7B are views for explaining a second embodiment of the integrated inductor of the present disclosure, and FIG. 6 is a perspective view while FIGS. 7A and 7B show cross-sections taken along 2-2 and 3-3, respectively, of FIG. 6.

An integrated inductor 51 is a ferrite inductor made up of E-cores 61, 71 having an E-shaped cross-section made of ferrite, a plate-like I-core 81 made of ferrite, coils 11, 21 of insulation-coated conductive wires wound edgewise into a ring shape, and a base 91 made of a resin.

The E-cores 61, 71 respectively have the coils 11, 21 stored therein and are disposed on both sides of the I-core 81 and mounted on the base 91. End portions 11a, 11b of the coil 11 and end portions 21a, 21b of the coil 21 are led out from a lower surface of the base 91 as mounting terminals with the insulation coating partially peeled off.

A center C₆₁ of a middle leg 61a of the E-core 61 and a center C₇₁ of a middle leg 71a of the E-core 71 are provided off-center in opposite directions from each other. Therefore, when assembled, the positions of the centers of the middle legs are shifted from each other. Additionally, the integrated inductor 51 has gaps G provided between the middle leg of the E-core 61 and the I-core 81 as well as between the middle leg of the E-core 71 and the I-core 81.

FIG. 8 is a graph showing a result of simulation of the coupling coefficient between the coil 11 and the coil 21 when the axial interval S is varied in the integrated inductor 51 of this embodiment. In FIG. 8, the horizontal axis indicates S/D and the vertical axis indicates the coupling coefficient k. In this case, the coils 11, 21 have the average diameter D=5.8 mm.

From the result of FIG. 8, it can be understood that while the coupling coefficient k is 2.4% in the case of S/D=0 (the axial interval S=0, i.e., the same structure as the conventional integrated inductor), the coupling coefficient k is substantially zero at S/D=0.69 (the axial interval S=4 mm).

For example, in a digital amplifier circuit using a BTL (Bridge Tied Load) connection frequently used as a digital amplifier, two inductors are used for each channel and, therefore, a total of four inductors are required for two left and right channels.

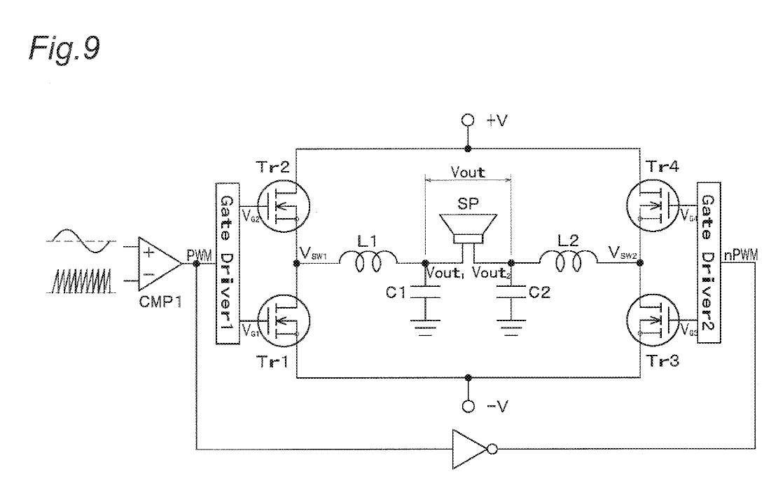

FIG. 9 is a circuit diagram of one channel of a digital amplifier using a BTL connection.

N-type MOS transistors Tr2, Tr1 connected in series and n-type MOS transistors Tr4, Tr3 connected in series are connected between power sources +V, −V.

By comparing an input signal Vin input to a comparator CMP1 with a triangular wave reference signal, an input signal such as voice is PWM-modulated to generate a PWM signal. A gate driver 1 generates drive signals V_{G1}, V_{G2} of the transistors Tr1, Tr2 from the PWM signal. The drive signals V_{G1}, V_{G2} are connected to gates of the transistor Tr1 and the transistor Tr2.

A gate driver 2 generates drive signals V_{G3}, V_{G4} of the transistors Tr3, Tr4 from an nPWM signal acquired by inverting the PWM signal. The drive signals V_{G3}, V_{G4} are connected to gates of the transistor Tr3 and the transistor Tr4, respectively.

A connection point V_{SW1} of a drain of the transistor Tr1 and a source of the transistor Tr2 is input to an LC filter made up of an inductor L1 and a capacitor C1, and an output Vout1 is connected to one terminal of a speaker SP.

Similarly, a connection point V_{SW2} of a drain of the transistor Tr3 and a source of the transistor Tr4 is input to an LC filter made up of an inductor L2 and a capacitor C2, and an output Vout2 is connected to the other terminal of the speaker SP. A voltage between Vout1 and Vout2 will hereinafter be referred to as an output signal Vout.

In the case of stereo, another circuit similar to the circuit shown in FIG. 9 is required, and in such a case, an integrated inductor acquired by integrating four coils is useful for reducing the mounting area.

### Third Embodiment

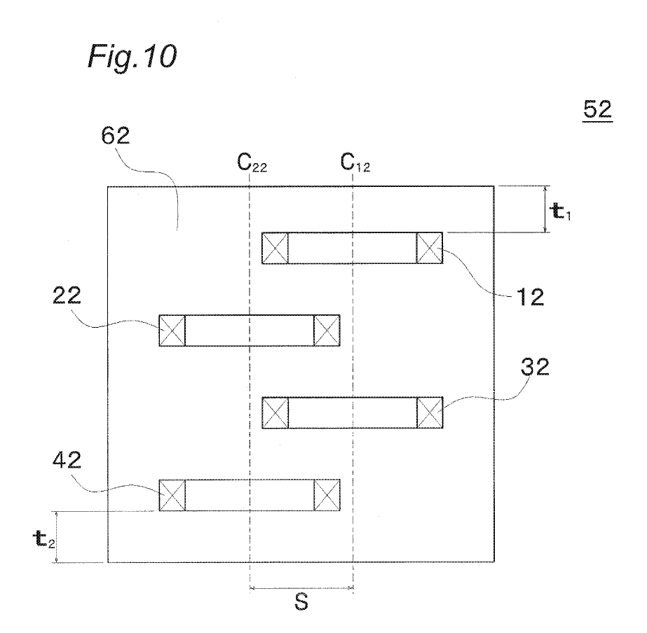

FIG. 10 is a longitudinal sectional view for explaining a third embodiment of the integrated inductor of the present disclosure. As shown in FIG. 10, an integrated inductor 52 is a dust inductor integrally molded with four coils 12, 22, 32, 42 of insulation-coated conductive wires wound into a ring shape and buried in a magnetic-powder-containing resin 62. The integrated inductor 52 is called a four-in-one inductor.

The coils 12, 22, 32, 42 have the same shape and the same size with opening planes arranged in parallel.

The coil 12 and the coil 32 have respective winding axes disposed on an axis C₁₂ and the coil 22 and the coil 42 have respective winding axes disposed on an axis C₂₂ such that the coils 12, 22, 32, 42 are in a staggered arrangement.

Terminals of the coils 12, 22, 32, 43 are led out to the exterior of the integrated inductor 52 as mounting terminals with the insulation coating peeled off.

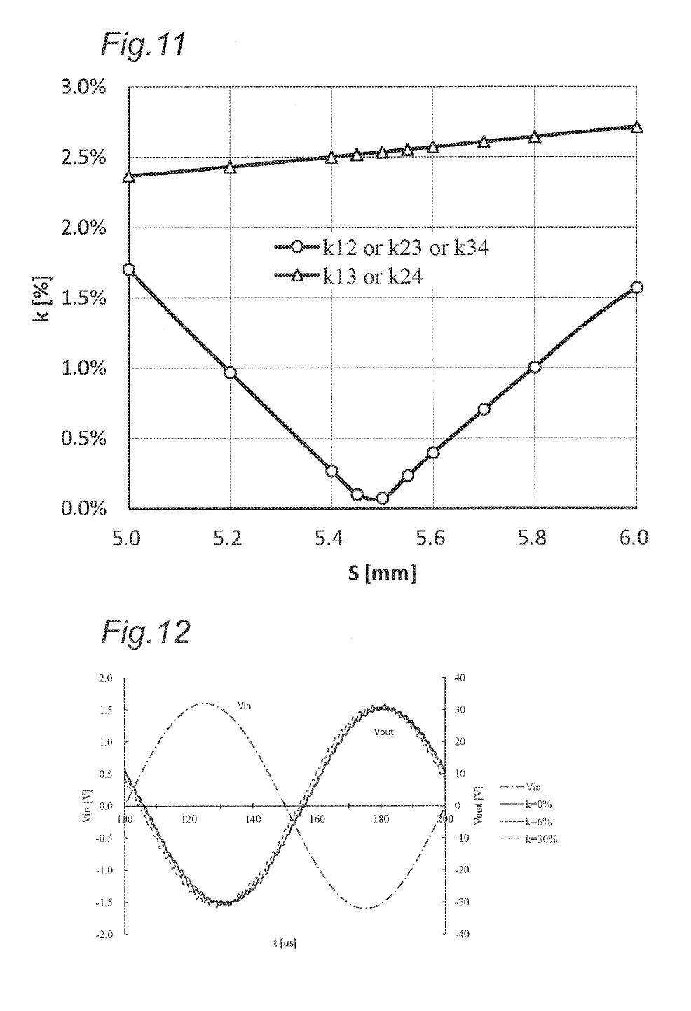

FIG. 11 is a graph showing a result of simulation of the coupling coefficient k with respect to the axial interval S between the axis C₁₂ and the axis C₂₂. In FIG. 11,

a circle indicates
a coupling coefficient k12 between the coil 12 and the coil 22,
a coupling coefficient k23 between the coil 22 and the coil 32, or
a coupling coefficient k34 between the coil 32 and the coil 42, and
a triangle indicates
a coupling coefficient k13 between the coil 12 and the coil 32, or
a coupling coefficient k24 between the coil 22 and the coil 42.

From the result shown in FIG. 11, it can be understood that while the coupling coefficient k can be set to zero between the adjacent coils on different straight lines, the coupling coefficient k cannot be set to zero between the coils having the winding axes on the same straight line even though being separated by a distance greater than that between the adjacent coils having the winding axes on different straight lines.

A simulation was performed to compare the waveforms of the input signal Vin and the output signal Vout of the LC filter when the coupling coefficient k between the inductor L1 and the inductor L2 was varied in the circuit diagram of FIG. 9. FIG. 12 is a graph showing the simulation result.

From the result of FIG. 12, it can be understood that while the output signal Vout is largely distorted in the case of the coupling coefficient k=30%, the signal is not so different in the case of the coupling coefficient k=6% from the case of the coupling coefficient k=0%.

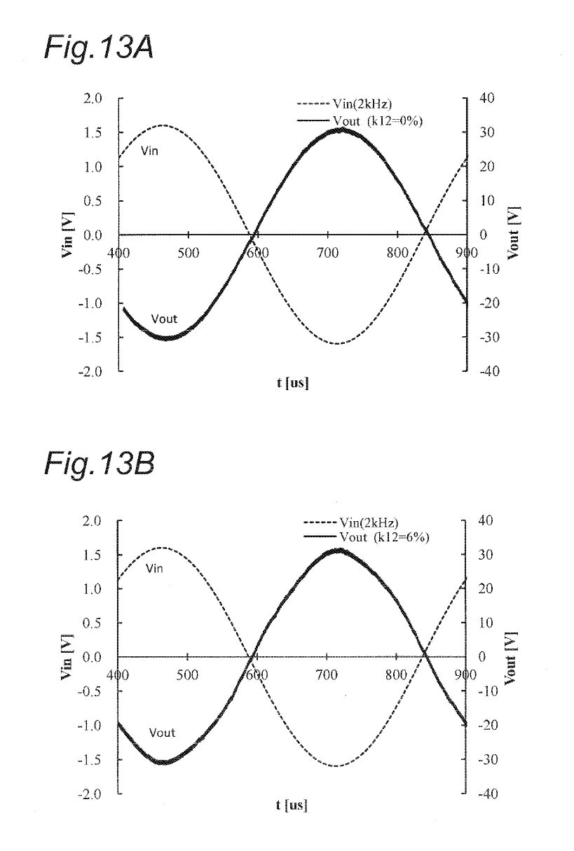

Additionally, two circuits CH1 and CH2 were each prepared as the circuit of FIG. 9, and a simulation was performed to compare the waveforms of the input signal of CH2 and the output signal Vout of CH2 when the coupling coefficient between the inductors L1 of CH1 and CH2 was 0% and 6%. FIGS. 13A and 13B are graphs showing the simulation results, and FIG. 13A shows the case of the coupling coefficient k=0 while FIG. 13B shows the case of the coupling coefficient k=6%. The input signal Vin of CH1 was a sine wave of 10 KHz, the input signal Vin of CH2 was a sine wave of 2 KHz, and the frequency of PWM modulation was 450 KHz.

From the results of FIGS. 13A and 13B, it can be understood that the waveform of the output signal of CH2 is distorted even in the case of the coupling coefficient k=6%.

From the results described above, it can be understood that while the coupling can be allowed to some extent between the inductors in the same channel in the LC filter circuit of the digital amplifier using a BTL connection because currents flowing through two coils are always the same, coupling between channels should be avoided as much as possible because different currents flow through two coils of different channels.

Therefore, it can be understood that when the integrated inductor 52 shown in FIG. 10 is used in the circuit diagram of the digital amplifier using a BTL connection shown in FIG. 9, it is optimal to use a pair of the coil 12 and the coil 32 for one channel and use a pair of the coil 22 and the coil 42 for the other channel.

In the integrated inductor 52, the coil 22 and the coil 32 have adjacent coils on both sides, while the coil 12 and the coil 42 have adjacent coils only on one side. Therefore, the coil 12 and the coil 22 as well as the coil 32 and the coil 42 cause a difference in inductance value even though the shapes are completely the same. In such a case, the inductances of the individual coils may be adjusted by a thickness t1 from the coil 12 to an end surface of the integrated inductor and a thickness t2 from the coil 42 to an end surface of the integrated inductor to optimize the characteristics of the integrated inductor.

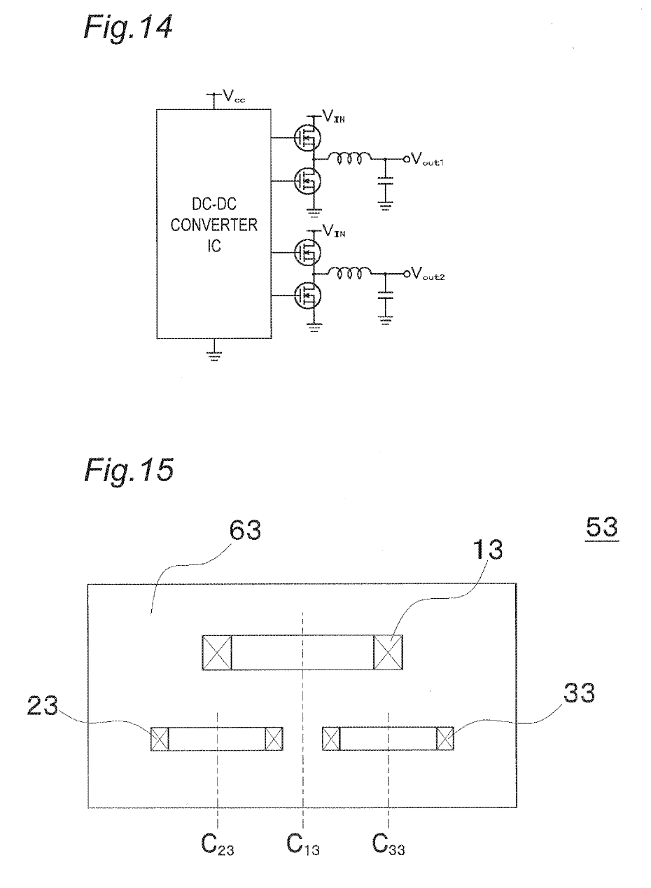

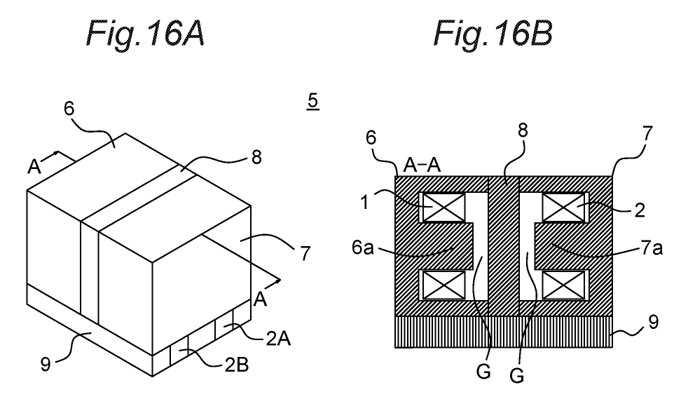

In this embodiment, the relationship of coupling of the four-in-one inductors has been described by using a digital amplifier circuit using a BTL connection; however, by adopting an integrated inductor not only in the digital amplifier but also in, for example, a multi-channel DC-DC converter shown in FIG. 14 in consideration of the relationship of coupling described above, the mounting area can be reduced and the stabilization of operation of the DC-DC converter can be ensured at the same time. Additionally, the number of coils to be integrated is not limited to two and four, and more coils may be integrated.

### Fourth Embodiment

Although the coils are all the same size in the embodiments described above, the coils may be different in size.

FIG. 15 is a longitudinal sectional view for explaining a fourth embodiment of the integrated inductor of the present disclosure.

As shown in FIG. 15, the integrated inductor 53 is a dust inductor integrally molded with a coil 13 and coils 23, 33 having a diameter smaller than the coil 13 buried in a magnetic-material-containing resin 63.

When the winding axes of the coil 13, the coil 23, and the coil 33 are an axis C₁₃, an axis C₂₃, and an axis C₃₃, respectively, the coil 13 has the axis C₁₃ between the axis C₂₃ of the coil 23 and the axis C₃₃ of the coil 33, and the coils 23, 33 have the opening planes arranged on the same plane, while the coil 13 is disposed on a level different from the coils 23, 33. In this case, the coupling coefficient is substantially zero between the coils 13 and 23 as well as between the coils 13 and 33 and, at the same time, the coupling coefficient between the coils 23 and 33 arranged on the same plane can be kept low because of the large axial interval completely separating the coils from each other.

As described above, the coil shapes are not limited to the same shape. For example, coils of various shapes such as oval and rectangular coil shapes other than a circular shape are usable. The present disclosure is applicable as long as the coils partially overlap with each other.

1. An integrated inductor acquired by integrating a plurality of coils, comprising:
a first coil group arranged with winding axes aligned on a first straight line; and
a second coil group arranged with winding axes aligned on a second straight line,
the first coil group and the second coil group having respective coils being in a staggered arrangement,
the first coil group and the second coil group having respective coils partially overlapping with each other when viewed in a winding axis direction.

2. The integrated inductor according to claim 1, wherein the first coil group consisting of one coil.

3. The integrated inductor according to claim 1, wherein the second coil group consisting of one coil.

4. The integrated inductor according to claim 1, wherein the integrated inductor is a dust inductor made of a magnetic-powder-containing resin.

5. The integrated inductor according to claim 1, wherein the integrated inductor is made up of a plate-like core and cores having an E-shaped cross-section disposed on both sides of the plate-like core.

6. The integrated inductor according to claim 1, wherein
the plurality of coils is four coils, wherein
the first coil group is used as a pair in one of two symmetrical circuits, and wherein
the second coil group is used as a pair in the other of the two symmetrical circuits.
